(19) United States
(12) Patent Application Publication
(10) Pub. No.: US 2020/0112785 A1
(43) Pub. Date: Apr. 9, 2020

(54) ACOUSTICALLY ACTIVE NANO-STRUCTURED METAL OXIDES

(71) Applicant: 3M INNOVATIVE PROPERTIES COMPANY, St. Paul, MN (US)

(72) Inventors: Mahmut Aksit, Woodbury, MN (US); Fabian Stolzenburg, Woodbury, MN (US)

(21) Appl. No.: 16/624,471

(22) PCT Filed: Jun. 12, 2018
(86) PCT No.: PCT/IB2018/054250

§ 371 Date: Dec. 19, 2019

Related U.S. Application Data
(60) Provisional application No. 62/524,013, filed on Jun. 23, 2017.

(51) Int. Cl. H04R 1/28; C01G 51/00

(52) U.S. Cl. CPC H04R 1/288; C01G 51/42; C01G 51/66; C01P 2004/61; C01P 2004/64; C01P 2006/14; C01P 2006/12

(57) ABSTRACT

Acoustically active articles having a composition including a nano-structured metal oxide are provided. The nano-structured metal oxide has the formula M1xM2yOz, where M1 is selected from the group consisting of alkali metals, alkaline earth metals, and combinations thereof, M2 is a transition metal or post-transition metal, and M2 has an atomic number no greater than 78. The articles can lower a resonant frequency of a cavity by no less than 50 Hz when the cavity is filled with the article and the resonant frequency is in a range from about 50 Hz to about 1500 Hz.

### FIELD OF THE DISCLOSURE

This disclosure relates to acoustically active articles including nano-structured metal oxides, and methods of making and using the articles for acoustic applications.

### BACKGROUND

Acoustic components of electronic devices such as speakers in handheld electronic devices have become smaller and smaller as the devices become thinner Small enclosure cavities in the devices make it difficult to achieve rich sounds in the low-frequency range (e.g., about 50 Hz to about 1500 Hz). Acoustically active materials placed inside the speaker enclosure can help lower the resonant frequency of the device. The most commonly used acoustically active materials include, for example, zeolite and activated carbon.

### SUMMARY

There is a desire to make acoustically active materials that can offer potential advantages over the commonly used materials (e.g., zeolite or activated carbon). For example, activated carbon is highly hydrophilic and may deteriorate in humidity environment, while zeolites tend to be relatively expensive.

In one aspect, the present disclosure describes an acoustically active article having a composition including a nano-structured metal oxide having the formula M1ₓM2_{y}O_{z}. M1 is selected from the group consisting of alkali metals, alkaline earth metals, and combinations thereof. M2 is a transition metal or post-transition metal, and M2 has an atomic number no greater than 78. X is a number in the range 0≤x≤2, y is a number in the range 0.4≤y≤1.2, and z is a number selected such that the nano-structured metal oxide is electrically neutral. In some embodiments, x is a number in the range 0.7≤x≤1.5, and y is a number in the range 0.7≤y≤1.0. In some embodiments, the acoustically active article can decrease a resonant frequency of a cavity by no less than 50 Hz when the cavity is filled with the article and the resonant frequency of the cavity is in a range from about 50 Hz to about 1500 Hz.

In another aspect, the present disclosure describes a method of enhancing the performance of an acoustic device. The method includes providing an acoustic device having a cavity; and providing an acoustically active article to at least partially fill the cavity. The acoustically active article has a composition including a nano-structured metal oxide having the formula M1ₓM2_{y}O_{z}. M1 is selected from the group consisting of alkali metals, alkaline earth metals, and combinations thereof. M2 is a transition metal or post-transition metal, and M2 has an atomic number no greater than 78. X is a number in the range 0≤x≤2, y is a number in the range 0.4≤y≤1.2, and z is a number selected such that the nano-structured metal oxide is electrically neutral. In some embodiments, x is a number in the range 0.7≤x≤1.5, and y is a number in the range 0.7≤y≤1.0. In some embodiments, the article is capable of lowering a resonant frequency of a cavity by no less than 50 Hz when the cavity is filled with the article and the resonant frequency of the cavity is in a range from about 50 Hz to about 1500 Hz.

Various unexpected results and advantages are obtained in exemplary embodiments of the disclosure. One such advantage of exemplary embodiments of the present disclosure is that the acoustically active articles including nano-structured metal oxides can exhibit unexpected acoustic properties. When placed inside acoustic cavities, the acoustically active nano-structured metal oxides can shift the resonance frequencies of the empty acoustic cavities to lower frequencies as desired for numerous acoustic applications. While the nano-structured metal oxides described herein have significantly lower surface area (e.g., less than 10 m²/g) or pore volume as compared to traditional materials (e.g., activated carbon having a typical surface area greater than 100 m²/g, and zeolite materials having a typical surface area greater than 350 m²/g), the acoustically active articles made of or containing the nano-structured metal oxides still exhibit superior acoustic properties.

Various aspects and advantages of exemplary embodiments of the disclosure have been summarized. The above Summary is not intended to describe each illustrated embodiment or every implementation of the present certain exemplary embodiments of the present disclosure. The Drawings and the Detailed Description that follow more particularly exemplify certain preferred embodiments using the principles disclosed herein.

### BRIEF DESCRIPTION OF THE DRAWINGS

FIG. 1 shows acoustic resonance curves for nano-structured metal oxide material samples and reference samples.

FIG. 2 shows sound pressure level (SPL) measurement for nano-structured metal oxide material samples and reference samples.

In the following description of the illustrated embodiments, reference is made to the accompanying drawings, in which is shown by way of illustration, various embodiments in which the disclosure may be practiced. It is to be understood that the embodiments may be utilized and structural changes may be made without departing from the scope of the present disclosure. The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

For the following Glossary of defined terms, these definitions shall be applied for the entire application, unless a different definition is provided in the claims or elsewhere in the specification.

### Glossary

Certain terms are used throughout the description and the claims that, while for the most part are well known, may require some explanation. It should be understood that:

The term “nano-structured metal oxide” refers to metal oxides having the formula M1ₓM2_{y}O_{z}. M1 is selected from the group consisting of alkali metals, alkaline earth metals, and combinations thereof, M2 is a transition metal or post-transition metal, and M2 has an atomic number no greater than 78. The metal oxide presents in the form of nanostructures (e.g., particles or flakes) having at least one dimension size less than one micron.

The term “pore volume” is defined according to ASTM standard D4641-12. The term “surface area” is defined according to ASTM standard D3663-03 (2018).

The terms “about” or “approximately” with reference to a numerical value or a shape means +/−five percent of the numerical value or property or characteristic, but expressly includes the exact numerical value. For example, a viscosity of “about” 1 Pa-sec refers to a viscosity from 0.95 to 1.05 Pa-sec, but also expressly includes a viscosity of exactly 1 Pa-sec. Similarly, a perimeter that is “substantially square” is intended to describe a geometric shape having four lateral edges in which each lateral edge has a length which is from 95% to 105% of the length of any other lateral edge, but which also includes a geometric shape in which each lateral edge has exactly the same length.

The term “substantially” with reference to a property or characteristic means that the property or characteristic is exhibited to a greater extent than the opposite of that property or characteristic is exhibited. For example, a substrate that is “substantially” transparent refers to a substrate that transmits more radiation (e.g. visible light) than it fails to transmit (e.g. absorbs and reflects). Thus, a substrate that transmits more than 50% of the visible light incident upon its surface is substantially transparent, but a substrate that transmits 50% or less of the visible light incident upon its surface is not substantially transparent.

Speakers in handheld electronic devices have gotten very small over the last few generations. The small cavities make it very hard to achieve rich sounds in the low-frequency range. Acoustically active materials have been placed inside the cavity to help lower the resonant frequency of the cavity. The most commonly used, acoustically active materials currently are zeolite and activated carbon. These acoustically active materials have relatively high pore volumes and/or high surface area per unit weight. It was observed in U.S. Pat. No. 8,767,998 that the pore volume for activated carbon powder should be at least 0.6 ml/g to obtain sufficient bass reproduction function. Alternative porous materials are described, for example, in PCT/US2016/068275 (Stolzenburg et al.) where agglomerated, highly porous alumina, zirconia, or ferrous hydrates, can offer potential advantages over the commercially available acoustically active materials (e.g., zeolite, activated carbon, etc.).

The present disclosure provides acoustically active materials or articles having a composition including a nano-structured metal oxide having the formula M1ₓM2_{y}O_{z}, where M1 is selected from the group consisting of alkali metals, alkaline earth metals, and combinations thereof, M2 is a transition metal or post-transition metal, and M2 has an atomic number no greater than 78, and x is a number in the range 0≤x≤2, y is a number in the range 0.4≤y≤1.2, z is a number selected such that the nano-structured metal oxide is electrically neutral (i.e., not electrically charged). In some embodiments, x is a number in the range 0.7≤x≤1.5, and y is a number in the range 0.7≤y≤1.0.

One advantage of exemplary embodiments of the present disclosure is that the acoustically active articles including nano-structured metal oxides can exhibit unexpected acoustic properties. When placed inside acoustic cavities, the acoustically active nano-structured metal oxides can shift the resonance frequencies of the empty acoustic cavities to lower frequencies as desired for numerous sound generation applications. While the nano-structured metal oxides described herein have significantly lower surface area (e.g., less than 10 m²/g) or pore volume as compared to traditional materials (e.g., activated carbon having a typical surface area greater than 100 m²/g, and zeolite materials having a typical surface area greater than 350 m²/g), the acoustically active articles made of or containing the nano-structured metal oxides still exhibit superior acoustic properties.

The nano-structured metal oxide described herein has the formula M1ₓM2_{y}O_{z}. In some embodiments, M1 is selected from the group consisting of alkali metals (e.g., Li, Na, K, Cs), alkaline earth metals (e.g., Be, Mg, Ca, Ba, Sr), and combinations thereof. In some embodiments, M1 is an alkali metal or a combination thereof. In some embodiments, M1 is a mixture of alkali metal and alkaline earth metal. M2 is a transition metal or post-transition metal, where M2 has an atomic number no greater than 78. Examples may include Al, Sc, Ti, V, Cr, Mn, Fe, Co, Ni, Cu, Zn, Ga, Ge, Y, Zr, Nb, Mo, (Tc), Ru, Rh, Pd, Ag, Cd, In, Sn, Sb, Lu, Hf, Ta, W, Re, Os, Ir, and Pt.

In some embodiments, the nano-structured metal oxide has the formula M1ₓM2_{y}O_{z}, where M1 may include at least one of Na, Ca, Li, and K, and M2 may include at least one of Co and Mn, and where x is a number in the range 0≤x≤2, y is a number in the range 0.4≤y≤1.2, z is a number selected such that the nano-structured metal oxide is electrically neutral (i.e., not electrically charged). In some embodiments, x is a number in the range 0.7≤x≤1.5, y is a number in the range 0.7≤y≤1.0.

In some embodiments, the nano-structured metal oxide M1ₓM2_{y}O_{z} may include one or more of Na—Mn—O, K—Co—O, Ca—Mn—O, Li—Co—O, Na—Co—O, Ca—Co—O, Li—Mn—O, or combinations thereof, where x is a number in the range 0≤x≤2, y is a number in the range 0.4≤y≤1.2, z is a number selected such that the nano-structured metal oxide is electrically neutral (i.e., not electrically charged). In some embodiments, x is a number in the range 0.7≤x≤1.5, y is a number in the range 0.7≤y≤1.0.

In some embodiments, the nano-structured metal oxide material may include a mixture of two or more metal oxides such as, for example, Na—Mn—O, K—Co—O, Ca—Mn—O, Li—Co—O, Na—Co—O, Ca—Co—O, Li—Mn—O, etc. The amount of metal oxides to be mixed in the composition may be any value that imparts suitable acoustic properties to the acoustically active article made from or containing the nano-structured metal oxides.

In some embodiments, the nano-structured metal oxide material may include multiple crystalline phases including, for example, a primary crystalline phase (e.g., single crystalline phase), a secondary crystalline phase (e.g., a polycrystalline phase), a partially amorphous phase, etc.

In some embodiments, the nano-structured metal oxide having the formula M1ₓM2_{y}O_{z} may present in the form of nanostructures such as, e.g., particles or flakes. The particles or flakes may have a dimension, for example, in the range of about 50 nm to about 50 microns. In some embodiments, the particles or flakes may have a ratio of thickness and length (width), for example, in the range between 1:1 and 1:1000. In some embodiments, the flakes may be oriented substantially parallel to each other. In some embodiments, a majority of the nano-structured metal oxide (e.g., at least 50 wt %, at least 60 wt %, at least 70 wt %, at least 80 wt %, at least 90 wt %, or at least 99 wt %) is in the form of flakes or particles.

In some embodiments, the nano-structured metal oxide described herein having the formula M1ₓM2_{y}O_{z} constitutes a majority of the acoustically active material (e.g., at least 50 wt %, at least 60 wt %, at least 70 wt %, at least 80 wt %, at least 90 wt %, or at least 99 wt %) in the composition of the acoustically active article. In some embodiments, the composition may include less than 50 wt %, less than 20 wt %, less than 10 wt %, less than 5 wt %, less than 1 wt %, or less than 0.5 wt % of one or more optional acoustically active materials other than the metal oxide M1ₓM2_{y}O_{z}. The optional acoustically active materials may include, for example, activated carbon, zeolite, silica (SiO₂), alumina (Al₂O₃), zirconia (ZrO₂), magnesia (MgO), iron oxide black (Fe₃O₄), molecular sieve, fullerene, carbon nanotube, etc.

In some embodiments, an acoustically active article described herein may include about 50 wt % to about 100 wt % of the nano-structured metal oxide having the formula M1ₓM2_{y}O_{z}. The nano-structured metal oxide can be loaded with a filler or binder material to form various structures such as, for example, a film, a foam, a fiber mat, etc. The acoustically active article may include optional binder or filler materials to facilitate the loading of the nano-structured metal oxide materials described herein to an acoustic device, e.g., an enclosed cavity. Typical binder or filler materials may include, for example, resin materials such as, for example, polyethylene resins or polyolefin resins. Exemplary binder materials are described in, for example, U.S. Pat. Nos. 8,335,333 and 8,794,373.

In some embodiments, the nano nano-structured metal oxide described herein having the formula M1ₓM2_{y}O_{z} may present in the form of particles or flakes which can be packaged in small pouches before filling a cavity. In some embodiments, the particles or flakes can be held together using polymer scaffolds or binders. Typical polymer scaffold or binder materials may include, for example, acrylate, polyacrylate, polyurethane, etc. In some embodiments, the acoustically active article can be provided in the form of a film, a foam, or a fiber mat.

In some embodiments, an acoustically active article described herein may contain, for example, less than 20 wt %, less than 15 wt %, less than 10 wt %, less than 5 wt %, less than 2 wt %, or less than 1 wt % matrix materials to distribute the nano-structured metal oxide. Typical matrix materials may include, for example, polymer matrix materials such as polyimide, resins, greases, etc. In some embodiments, the composition of the acoustically active articles or materials in the present disclosure may contain from about 4 wt % to about 12 wt % matrix materials. In some embodiments, the composition of the acoustically active articles or materials in the present disclosure may be substantially free of typical matrix materials.

In general, the acoustically active materials or articles described herein may have a significantly lower pore volume compared to traditional acoustically active materials such as zeolites and activated carbon. In some embodiments, the acoustically active materials or articles described herein may have a pore volume, for example, in the range from about 0.002 ml/g to about 2.0 ml/g, from about 0.005 ml/g to about 1 ml/g, from about 0.005 ml/g to about 0.5 ml/g, or from about 0.005 ml/g to about 0.2 ml/g. Traditional acoustically active materials such as zeolites and activated carbon include a large number of pores and the corresponding cumulative pore volume is greater than, for example, about 0.6 ml/g.

In general, the acoustically active materials or articles described herein may have a significantly lower surface area compared to traditional acoustically active materials such as zeolites and activated carbon. In some embodiments, the acoustically active materials or articles described herein may have a surface area per unit weight in the range, for example, about 0.5 m²/g to about 100 m²/g, about 1 m²/g to about 50 m²/g, about 1 m²/g to about 20 m²/g, about 1 m²/g to about 10 m²/g, about 1 m²/g to about 5 m²/g, or about 2 m²/g to about 3 m²/g. Typical activated carbon materials have a surface area per unit weight in the range of 100 m²/g to 3500 m²/g. Typical zeolite materials have a surface area per unit weight greater than 350 m²/g.

In some embodiments, the acoustically active materials or articles described herein can lower a resonant frequency of a cavity by no less than 50 Hz when the cavity is at least partially filled with the article and the resonant frequency is in a range from about 50 Hz to about 1500 Hz. In some embodiments, the cavity may have a volume from about 0.1 cm³ to about 1000 cm³. It is to be understood that the volume, shape, or geometry of the cavity may vary for desired acoustic applications. It is also to be understood that while it does not need to be completely fill the cavity to observe the desired acoustic effect, a better performance can be typically achieved when the cavity is filled with as much acoustically active materials as possible, as long as the acoustic properties of the materials are maintained after the filling.

The nano-structured metal oxides described herein having the formula M1ₓM2_{y}O_{z} in the composition may be obtained from commercial sources or made according to known procedures. For example, suitable methods for making single crystal mixed metal oxide nanosheet material compositions are described in U.S. Pat. Appln. Publ. No. 2014/0093778 A1 (Aksit et al.); methods for making Ca₃Co₄O₉ nano-platelets using polymerized complex sol-gel are described in Applied Physics Letters 104, 16901 (2014).

The acoustically active materials or articles of this disclosure can be incorporated into a wide variety of acoustic devices to impart acoustic properties to the devices. Examples of acoustic device can be, for example, a speaker, a microphone, etc., that can be used by an electronic device such as handheld electronic devices.

Various embodiments are provided, including acoustically active articles, methods of making and using the articles.

Embodiment 1 is an acoustically active article having a composition comprising:

a nano-structured metal oxide having the formula M1ₓM2_{y}O_{z},

wherein M1 is selected from the group consisting of alkali metals, alkaline earth metals, and combinations thereof, M2 is a transition metal or post-transition metal, and M2 has an atomic number no greater than 78, and x is a number in the range 0≤x≤2, y is a number in the range 0.4≤y≤1.2, z is a number selected such that the nano-structured metal oxide is electrically neutral, and

wherein the article is capable of lowering a resonant frequency of a cavity by no less than 50 Hz when the cavity is filled with the article and the resonant frequency is in a range from about 50 Hz to about 1500 Hz.

Embodiment 2 is the article of embodiment 1, wherein M1 includes at least one of Na, Ca, Li, and K.
Embodiment 3 is the article of embodiment 1 or 2, wherein M2 includes at least one of Co and Mn.
Embodiment 4 is the article of any one of embodiments 1-3, wherein the nano-structured metal oxide comprises one or more of Na—Mn—O, K—Co—O, Ca—Mn—O, Li—Co—O, Na—Co—O, Ca—Co—O, Li—Mn—O, combinations thereof.
Embodiment 5 is the article of any one of embodiments 1-4, wherein the nano-structured metal oxide is present in the form of particles or flakes.
Embodiment 6 is the article of embodiment 5, wherein the particles or flakes have a dimension in the range of 50 nm to 50 microns.
Embodiment 7 is the article of any one of embodiments 1-6, wherein the article has a pore volume no greater than 0.5 ml/g.
Embodiment 8 is the article of embodiment 7, wherein the article has a pore volume in the range of 0.005 ml/g and 0.5 ml/g.
Embodiment 9 is the article of any one of embodiments 1-8, wherein the article has a surface area per unit weight no greater than 10 m²/g.
Embodiment 10 is the article of any one of embodiments 1-9, wherein the article has a surface area per unit weight in the range from 1.0 m²/g to 5 m²/g.
Embodiment 11 is the article of any one of embodiments 1-10, wherein the article includes about 4 wt % to about 12 wt % matrix material to distribute the nano-structured metal oxide.
Embodiment 12 is the article of any one of embodiments 1-11, wherein the article comprises about 50 wt % to about 100 wt % of the nano-structured metal oxide.
Embodiment 13 is the article of embodiment 9, wherein the article comprises about 0 wt % to about 50 wt % of a filler or binder.
Embodiment 14 is a method of enhancing the performance of an acoustic device, the method comprising:

providing an acoustic device having a cavity; and

providing the article of any one of the proceeding embodiments to at least partially fill the cavity.

Embodiment 15 is the method of embodiment 14, wherein the article is provided in the form of a film, a foam, or a fiber mat.
Embodiment 16 is the method of embodiment 14 or 15, wherein the cavity has a volume from 0.1 cm³ to 1000 cm³.
Embodiment 17 is the method of any one of embodiments 14-16, wherein the acoustic device comprises a speaker or a microphone.
Embodiment 18 is a method of making the article of any one of embodiments 1-13, the method further comprising loading the nano-structured metal oxide with a filler or binder material.

### Examples

These examples are merely for illustrative purposes and are not meant to be limiting on the scope of the appended claims. All parts, percentages, ratios, etc. in the examples and the rest of the specification are by weight, unless noted otherwise.

### I. Preparation of Acoustically Active Nano-Structured Metal Oxide Particles or Flakes:

An aqueous solution was prepared at room temperature by mixing appropriate quantities of organic complexing agents (Organic Compl.) and nitrate/carbonate salts of metal species.

To make metal oxide nano-structured materials having the formula M1ₓM2_{y}O_{z}, polyacrylic acid (PAA with an average molecular weight Mw about 5000 g/mol, 50% in water, Polysciences, Inc., Warrington, Pa.) was mixed with M1-nitrate/carbonate (m Molar) and M2-nitrate (n Molar) in de-ionized water. Here molarities m and n were such that M1 to M2 cation ratio in the solution is set to x/y. For certain metal oxides, citric acid (CA) instead of PAA were used, which can lead to different crystal anisotropy thus different acoustic properties. For example, NaxCoO₂ used PAA instead of CA, which typically led to a more anisotropic final product. The ratio of carboxylate groups (from PAA or CA) to total metal ions was set to about 1:2.

The aqueous solution was stirred and evaporated on a hotplate until it reached 20% of the initial volume. The temperature of the hot plate was adjusted to maximize evaporation rate without boiling. The resulting dark red solution was then auto-combusted on a hot plate or electric burner. When a hot plate was used, the temperature of the hot plate was set to >500° C. for auto-combustion to take place. The resulting black powder was then calcined in a box furnace for 6 hours at calcination temperature (Cal. Temp.) of 650° C. or 900° C. The calcined powder was characterized by Scanning Electron Microscopy (SEM) and/or X-ray Diffraction (XRD) for structural analysis.

Table 1 below shows synthesis details for various nano-structure metal oxide samples having the formula M1ₓM2_{y}O_{z}.

TABLE 1

| | | | | M2 | Intended | | Cal. |
|---|---|---|---|---|---|---|---|
| | M1 | M1 Prec. | M2 | Prec. | M1/M2 | Organic | Temp. |
| Examples | Precursor | Molarity | Precursor | Molarity | ratio | Compl. | (° C.) |
| NaMnO- | Sodium | 0.17 | Manganese (II) | 0.12-0.17 | 0.71-1 | PAA | 650 |
| 650 | Nitrate | | Nitrate × | | | | |
| | | | Hydrate | | | | |
| CaMnO- | Calcium | 0.84 | Manganese (II) | 0.6-0.84 | 0.71-1 | PAA | 650 |
| 650 | Nitrate | | Nitrate × | | | | |
| | TetraHydrate | | Hydrate | | | | |
| CaMnO- | Calcium | 0.84 | Manganese (II) | 0.6-0.84 | 0.71-1 | PAA | 900 |
| 900 | Nitrate | | Nitrate × | | | | |
| | TetraHydrate | | Hydrate | | | | |
| NaCoO- | Sodium | 0.37 | Cobalt Nitrate | 0.52 | 0.71 | PAA | 650 |
| HA-650 | Nitrate | | HexaHydrate | | | | |
| NaCoO- | Sodium | 0.37 | Cobalt Nitrate | 0.52 | 0.71 | PAA | 900 |
| HA-900 | Nitrate | | HexaHydrate | | | | |
| NaCoO- | Sodium | 0.37 | Cobalt Nitrate | 0.52 | 0.71 | CA | 650 |
| LA-650 | Nitrate | | HexaHydrate | | | | |
| NaCoO- | Sodium | 0.37 | Cobalt Nitrate | 0.52 | 0.71 | CA | 900 |
| LA-900 | Nitrate | | HexaHydrate | | | | |
| CaCoO- | Calcium | 0.39 | Cobalt Nitrate | 0.52 | 0.75 | PAA | 650 |
| 650 | Nitrate | | HexaHydrate | | | | |
| | TetraHydrate | | | | | | |
| KCoO-650 | Potassium | 0.34 | Cobalt Nitrate | 0.34 | 1 | PAA | 650 |
| | Nitrate | | HexaHydrate | | | | |
| LiCoO- | Lithium | 0.34 | Cobalt Nitrate | 0.34 | 1 | PAA | 650 |
| 650 | Nitrate | | HexaHydrate | | | | |
| Co₃O₄-650 | N/A | N/A | Cobalt Nitrate | 0.34 | N/A | PAA | 650 |
| | | | HexaHydrate | | | | |

Notes for NaMnO-650: 1) Varying complex water amount in manganese precursor led to a range in M2 molarity and intended M1/M2 ratio; 2) XRD indicated a mixture of different phases.
Notes for CaMnO-650: 1) Varying complex water amount in manganese precursor led to a range in M2 molarity and intended M1/M2 ratio; 2) XRD indicated a mixture of different phases; 3) According to SEM metal oxide nano-particles are mostly isotropic.
Notes for CaMnO-900: 1) Varying complex water amount in manganese precursor led to a range in M2 molarity and intended M1/M2 ratio; 2) XRD indicated a mixture of different phases; 3) According to SEM metal oxide nano-particles are mostly isotropic.
Notes for NaCoO-HA-650: 1) XRD matches closely with Na0.71CoO2 and Na_{0.6}CoO₂ phases; 2) NaxCoC₂ crystals are in the form of nano-platelets; 3) PAA leads to higher anisotropy.
Notes for NaCoO-LA-900: PAA leads to higher anisotropy NaxCoO₂ nano-platelets.
Notes for NaCoO-LA-650: CA leads to lower anisotropy NaxCoO₂ nano-platelets.
Notes for NaCoO-LA-900: CA leads to lower anisotropy NaxCoO₂ nano-platelets.
Notes for CaCoO-650: XRD confirms Ca₃Co₄O₉ phase.

### II. Acoustic Resonance Shift Measurement:

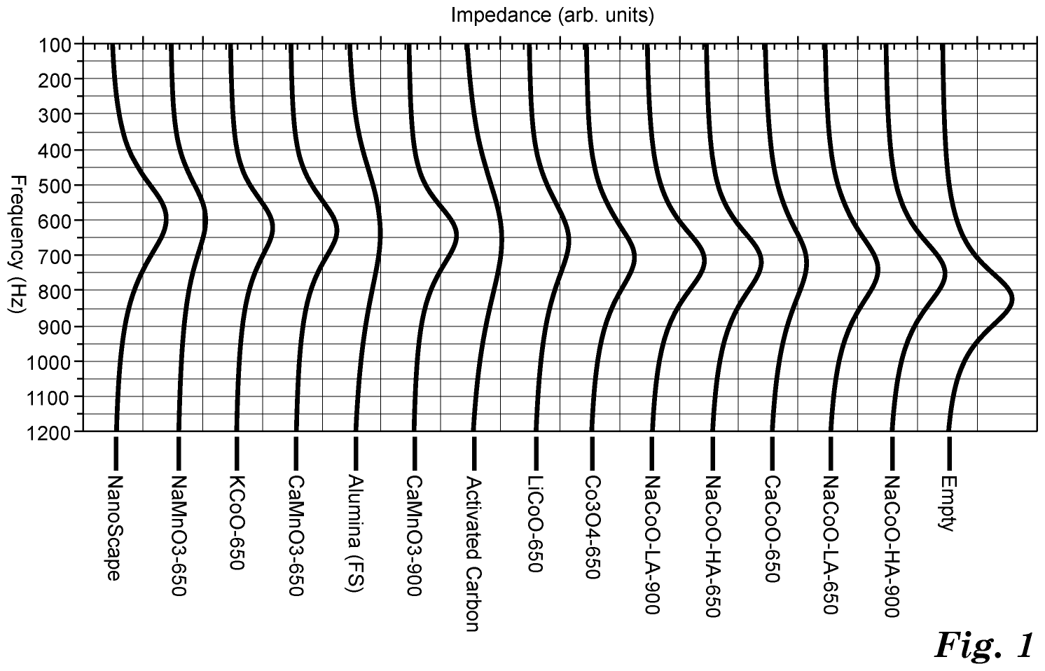

Acoustic resonance curves were obtained using standard Thiele-Small parameter analysis which was described in Small, R. H., “Closed-Box Loudspeaker Systems,” J. Audio Eng. Soc., vol. 20, pp. 798-808 (December 1972). An acoustic device including a small Knowles Electronics 2403-260-00001 11×15×3.5 mm speaker connected to a 0.928 cm³ cavity was tested. A DATS V2 Dayton Audio Test System, commercially available from Dayton Audio, 705 Pleasant Valley Dr., Springboro, Ohio 45066, was attached to the speaker and run to collect the resonant frequency peak in the audio range from 20 Hz to 20,000 Hz. This resonant frequency was respectively collected for the speaker in contact with the empty 0.928 cm³ cavity, and for the speaker in contact with the same cavity but filled with various acoustically active materials. The tested acoustically active materials included the samples listed in Table 1 above, and comparative samples including alumina agglomerate material as described in PCT/US2016/068275 (Stolzenburg et al.), and zeolite commercially available from NanoScape. FIG. 1 illustrates acoustic resonance curves for the empty cavity, and the same cavity filled with various acoustically active materials.

Acoustic Improvement Ratio (AIR value) of measured samples were also calculated using the acoustic resonance curves in FIG. 1. The AIR values were calculated from the ratio of the free-air speaker resonance, the empty closed cavity speaker resonance, and the filled cavity resonance as measured by the procedure described above. The AIR values were calculated according to the following formula: AIR=(Re−Rm)/(Re−Rfa), where Re is the empty Resonant Frequency Rf (˜825 Hz), Rm is the measured Rf, Rfa is the free air Rf, and Rfa=˜420 Hz. Table 2 lists the resonance frequencies, calculated AIR values and weight of various acoustically active material used in acoustic resonance shift measurements.

TABLE 2

| Examples | Mass fill (g) | Rf | AIR | Qms |
|---|---|---|---|---|
| Nano Scape | 0.3565 | 596.2 | 56.5% | 2.139 |
| NaMnO-650 | 0.1473 | 603.6 | 54.7% | 1.863 |
| KCoO-650 | 0.1540 | 623.1 | 49.9% | 2.535 |
| CaMnO₃-650 | 0.0970 | 629.2 | 48.3% | 2.592 |
| Alumina (FS) | 0.3150 | 631.9 | 47.7% | 1.374 |
| CaMnO₃-900 | 0.0830 | 644.0 | 44.7% | 2.839 |
| Activated Carbon | 0.3767 | 656.8 | 41.5% | |
| LiCoO-650 | 0.1463 | 658.8 | 41.0% | 2.064 |
| Co₃O₄-650 | 0.0640 | 705.2 | 29.6% | 2.287 |
| NaCoO-LA-900 | 0.1650 | 714.6 | 27.3% | 2.986 |
| NaCoO-HA-650 | 0.0660 | 719.3 | 26.1% | 2.953 |
| CaCoO-650 | 0.2271 | 723.4 | 25.1% | 2.287 |
| NaCoO-LA-650 | 0.0860 | 740.9 | 20.8% | 2.799 |
| NaCoO-HA-900 | 0.1360 | 744.9 | 19.8% | 3.127 |
| Empty | 0.0000 | 825.0 | 0.0% | 4.033 |

### III. Sound Pressure Level (SPL) Measurement:

To evaluate the effectiveness of each cavity-filling material, a sound pressure level (SPL) response test was conducted driving a Knowles Electronics model 2403-260-00001 speaker that was mounted to a fixture that provided a back volume air cavity. The air cavity volume was approximately 0.93 cc. The driving voltage was approximately 0.4 mVrms which was supplied in the form of a band-limited chirp from 0-3200 Hz. The voltage profile was identical for each material tested, and was generated by an HP model 35670 frequency analyzer (available from Keysight Technologies, Santa Rosa, Calif.). This frequency analyzer was also used to record the SPL from a Bruel and Kjaer type 4188-A-03 condenser microphone (available from Bruel & Kjaer, Norcross, Ga.) that was positioned approximately 2.54 cm from the fixture.

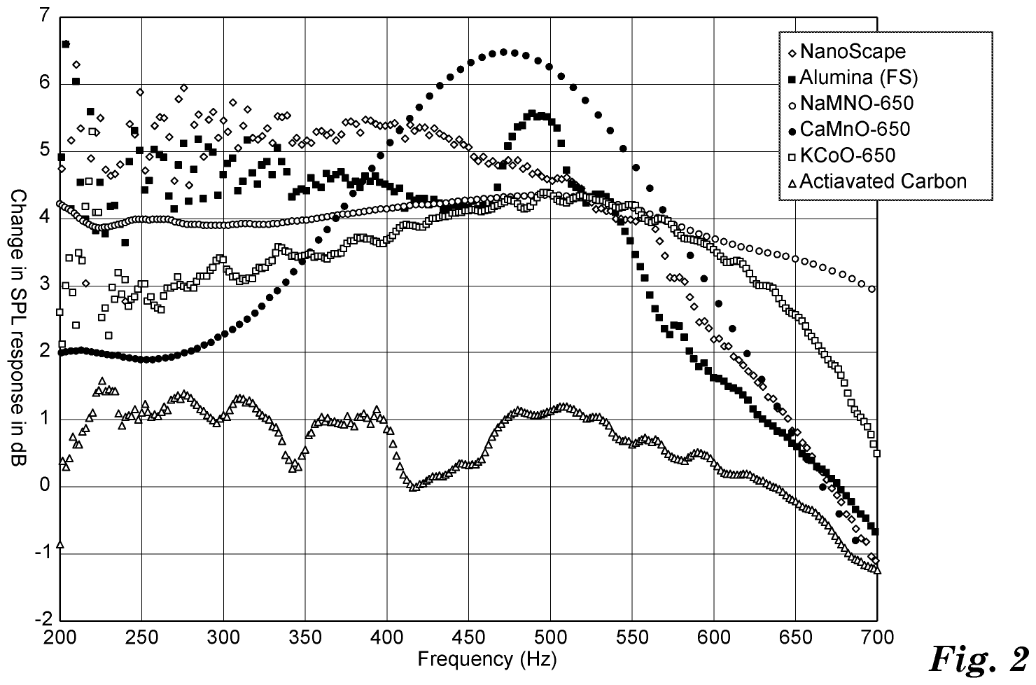

In small speakers for microelectronics the sound pressure rolls off below 10800 Hz is typical since these speakers are too small to be effective radiators for these very long waves (e.g., about 1 m at 350 Hz). Adding the acoustically active material, which adsorbs and desorbs gases (in response to acoustically generated pressure changes in the cavity) increases the compliance of the cavity and generates higher sound pressures at the lower frequencies. The range of interest is approximately 200-700 Hz. FIG. 2 illustrates SPL curves for the speaker filled with various materials (after subtracting the SPL curve of the speaker with an empty cavity). A positive number indicates an improvement in sound pressure level.

### IV. Data Analysis

Acoustic resonance curves in FIG. 1 and the resonance frequency values given in Table 2 indicate that acoustic resonance down shift has been observed in all nano-structured metal oxide material samples as compared to the empty cavity resonance (˜825 Hz). The highest resonance frequency downshift, thus higher AIR (see Table 2), was observed for NaMnO-650. The resonance frequency for NaMnO-650 was almost the same as the zeolite material commercially available from NanoScape, and lower than the alumina agglomerate material in PCT/US2016/068275 (Stolzenburg et al.).

Sharpness of most of the acoustic resonance curves for the nano-structured metal oxide materials was comparable to the zeolite material commercially available from NanoScape. The acoustic resonance curves for most of the nano-structured metal oxide materials were sharper than that of the alumina agglomerate material. This indicates lower absorption of sound waves by the nano-structured metal oxide materials as they downshift the resonance frequency of the acoustic cavity.

Table 2 indicates that similar resonance frequency downshifts can be obtained by significantly smaller amounts of the nano-structured metal oxide materials as compared to the comparative materials. For example, NaMnO-650 provides substantially the same resonance frequency downshift as compared to the zeolite material from NanoScape (603.6 Hz versus 596.2 Hz), but with 59 weight % less material. Similarly, CaMnO-650 provides slightly higher resonance frequency downshift as compared to the alumina sample (629.2 Hz versus 601.9 Hz), but with 69 weight % less material.

FIG. 2 shows that all nano-structured metal oxide materials measured for SPL provided positive SPL change at frequencies lower than 650 Hz. The positive SPL change between 400 and 550 Hz was significantly higher for CaMnO-650 as compared to the comparative samples (i.e., the zeolite material from NanoScape, activated carbon, and the alumina sample). Examples in this disclosure such as NaMnO-650 provided similar SPL curve compared to the comparative samples.

Reference throughout this specification to “one embodiment,” “certain embodiments,” “one or more embodiments” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus, the appearances of the phrases such as “in one or more embodiments,” “in certain embodiments,” “in one embodiment” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. In particular, as used herein, the recitation of numerical ranges by endpoints is intended to include all numbers subsumed within that range (e.g., 1 to 5 includes 1, 1.5, 2, 2.75, 3, 3.80, 4, and 5). In addition, all numbers used herein are assumed to be modified by the term “about.”

1. An acoustically active article having a composition comprising:
a nano-structured metal oxide having the formula M1ₓM2_{y}O_{z},
wherein M1 is selected from the group consisting of alkali metals, alkaline earth metals, and combinations thereof, M2 is a transition metal or post-transition metal, and M2 has an atomic number no greater than 78, and x is a number in the range 0≤x≤2, y is a number in the range 0.4≤y≤1.2, z is a number selected such that the nano-structured metal oxide is electrically neutral, and
wherein the article is capable of lowering a resonant frequency of a cavity by no less than 50 Hz when the cavity is filled with the article and the resonant frequency of the cavity is in a range from about 50 Hz to about 1500 Hz.

2. The article of claim 1, wherein M1 includes at least one of Na, Ca, Li, and K.

3. The article of claim 1, wherein M2 includes at least one of Co and Mn.

4. The article of claim 1, wherein the nano-structured metal oxide comprises one or more of Na—Mn—O, K—Co—O, Ca—Mn—O, Li—Co—O, Na—Co—O, Ca—Co—O, Li—Mn—O, combinations thereof.

5. The article of claim 1, wherein the nano-structured metal oxide is present in the form of particles or flakes.

6. The article of claim 5, wherein the particles or flakes have a dimension in the range of 50 nm to 50 microns.

7. The article of claim 1, wherein the article has a pore volume no greater than 0.5 ml/g.

8. The article of claim 7, wherein the article has a pore volume in the range of 0.005 ml/g and 0.5 ml/g.

9. The article of claim 1, wherein the article has a surface area per unit weight no greater than 10 m²/g.

10. The article of claim 1, wherein the article has a surface area per unit weight in the range from 1.0 m²/g to 5 m²/g.

11. The article of claim 1, wherein the article includes about 4 wt % to about 12 wt % matrix material to distribute the nano-structured metal oxide.

12. The article of claim 1, wherein the article comprises about 50 wt % to about 100 wt % of the nano-structured metal oxide.

13. The article of claim 12, wherein the article comprises about 0 wt % to about 50 wt % of a filler or binder.

14. A method of enhancing the performance of an acoustic device, the method comprising:
providing an acoustic device having a cavity; and
providing the article of claim 1 to at least partially fill the cavity.

15. The method of claim 14, wherein the article is provided in the form of a film, a foam, or a fiber mat.

16. The method of claim 14, wherein the cavity has a volume from 0.1 cm³ to 1000 cm³.

17. The method of claim 14, wherein the acoustic device comprises a speaker or a microphone.

18. A method of making the article of claim 1, the method further comprising loading the nano-structured metal oxide with a filler or binder material.
